(19) United States
(12) Patent Application Publication
(10) Pub. No.: US 2020/0251241 A1
(43) Pub. Date: Aug. 6, 2020

(54) ELECTRICALLY CONDUCTIVE MATERIALS FOR ELECTRIC CONTACTS

(71) Applicant: Xtalic Corporation, Marlborough, MA (US)

(72) Inventors: Evgeniya Freydina, Acton, MA (US); Robert D. Hilty, Walpole, MA (US)

(73) Assignee: Xtalic Corporation, Marlborough, MA (US)

(21) Appl. No.: 16/781,774

(22) Filed: Feb. 4, 2020

Related U.S. Application Data
(60) Provisional application No. 62/801,067, filed on Feb. 4, 2019.

(51) Int. Cl. H01B 1/08; C25D 5/12; C25D 7/00; C23C 28/02

(52) U.S. Cl. CPC H01B 1/08; C23C 28/02; C25D 7/00; C25D 5/12

(57) ABSTRACT

An electrical contact comprising a layer of a dark electrically conductive finish layer is generally described.

### RELATED APPLICATIONS

This application claims priority to U.S. Provisional Application No. 62/801,067, filed Feb. 4, 2019, which is incorporated herein by reference in its entirety.

### FIELD

Disclosed embodiments are related to electrically conductive materials for electrical contacts.

### BACKGROUND

Coating and/or finish materials for electrical contacts should ideally be electrically conductive. It may also be beneficial, in certain instances, to have a particularly dark (e.g., black) coating and/or finish for an electrical contact.

### SUMMARY

Electrical contact structures comprising a finish layer are described herein.

In one aspect, electrical contact structure is provided. The structure comprises a substrate and a finish layer formed on the substrate. The finish layer has a contact resistance of less than 1000 milliohms and a L* value of less than or equal to 60 as measured by CIE L*a*b*.

In one aspect, an electrical contact structure is provided. The structure comprises a substrate and a finish layer formed on the substrate. The finish layer comprises a ruthenium oxide and/or an iridium oxide. The finish layer further comprises one or more metals in an amount of greater than 0 at. % and less than or equal to 90 at. %.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments.

### DETAILED DESCRIPTION

An electrical contact structure comprising a finish layer is described herein. The finish layer may be both dark and electrically conductive. The finish layer can impart desirable characteristics to the electrical contact, such as appearance (e.g., color), electrical conductivity, durability and corrosion resistance, amongst others. The finish layer may be applied to the electrical contact structure by a suitable deposition techniques, such as electrodeposition. As described further below, the finish layer may comprise one or more metal oxides that have a dark color (e.g., ruthenium oxide, iridium oxide) and one or more metals (e.g., ruthenium). Resultantly, the finish layer may have a dark color (e.g., in part, at least, due to the one or more metal oxides) and may be electrically conductive (e.g., in part, at least, due to the one or more metals).

In certain embodiments, the finish layer comprises one or more metal oxides. In some embodiments, the one or more metal oxides are electrically conductive. The one or more metal oxides may have a dark color (e.g., when viewed by the naked human eye). Therefore, as will be explained herein in greater detail, the one or more metal oxides may improve the darkness of the finish layer.

The one or more metal oxides may be any metal oxide that imparts suitable properties. In some embodiments, the metal oxide is a ruthenium oxide. For example, the metal oxide may be a ruthenium oxide (e.g., RuO₂). In certain embodiments, the metal oxide may be an iridium oxide (e.g., IrO₂). Other metal oxides may also be possible.

The finish layer may comprise the one or more metal oxides in any of a variety of suitable amounts. For example, the layer may comprise one or more metal oxides in an amount greater than or equal to 1 weight percent (wt. %), greater than or equal to 2 wt. %, greater than or equal to 5 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, or greater than or equal to 80 wt. %. In certain embodiments, the layer comprises one or more metal oxides in an amount less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 2 wt. %. Combinations of the above recited ranges are also possible (e.g., the layer may comprise one or more metal oxides in an amount greater than 1 wt. % and less than or equal to 90 wt. %, the layer may comprise one or more metal oxides in an amount greater than or equal to 40 wt. % and less than or equal to 60 wt. %). Other combinations are also possible.

In certain embodiments, the finish layer further comprises one or more metals in addition to the metal oxide component(s). According to some embodiments, the one or more metals improve the durability and/or conductivity of the layer (e.g., as compared to a layer that does not comprise the one or more metals but is otherwise identical).

The one or more metals may be any of a variety of suitable metals. For example, the one or more metals may comprise a transition metal (e.g., any of the metallic d-block elements occupying the central block of groups 3-12 on the periodic table). In certain embodiments, the one or more metals are selected from the group consisting of Pt, Au, Ru, Ir, Rh, and/or mixtures thereof. In certain embodiments wherein the layer comprises two or more metals (e.g., three, four, five, etc. metals), the two or more metals may form an alloy.

The finish layer may comprise the one or more metals in any of a variety of suitable amounts. For example, the layer may comprise one or more metals in an amount greater than 0 atomic percent (at. %), greater than or equal to 1 at. %, greater than or equal to 2 at. %, greater than or equal to 5 at. %, greater than or equal to 10 at. %, greater than or equal to 20 at. %, greater than or equal to 30 at. %, greater than or equal to 40 at. %, greater than or equal to 50 at. %, greater than or equal to 60 at. %, greater than or equal to 70 at. %, or greater than or equal to 80 at. %. In some embodiments, the layer comprises one or more metals in an amount less than or equal to 90 at. %, less than or equal to 80 at. %, less than or equal to 70 at. %, less than or equal to 60 at. %, less than or equal to 50 at. %, less than or equal to 40 at. %, less than or equal to 30 at. %, less than or equal to 20 at. %, less than or equal to 10 at. %, less than or equal to 5 at. %, or less than or equal to 2 at. %, or less than or equal to 1 at. %. Combinations of the above recited ranges are also possible (e.g., the layer may comprise one or more metals in an amount greater than 0 at. % and less than or equal to 90 at. %, the layer may comprise one or more metals in an amount greater than or equal to 40 at. % and less than or equal to 60 at. %). Other combinations are also possible.

The composition of the finish layer may be characterized using suitable techniques known in the art, such as Auger electron spectroscopy (AES), X-ray photoelectron spectroscopy (XPS), scanning electron microscopy (SEM), and/or transmission electron microscopy (TEM). For example, AES and/or XPS may be used to characterize the chemical composition of the layer.

The finish layer may be a composite layer including the metal oxide component(s) described above and the metal component(s) described above. In some cases, the metal component may form a continuous (or semi-continuous) network in which discontinuous phases (e.g., islands) of the metal oxide component(s) are formed. In other cases, the metal component(s) and the metal oxide component(s) are discontinuous phases.

In some embodiments, the finish layer is at least partially crystalline. In some embodiments, for example, the layer may have a a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. According to some embodiments, the crystallinity of the finish layer may be adjusted using a heat treatment. In certain embodiments, the finish layer is at least partially amorphous. As known in the art, an amorphous structure is a non-crystalline structure characterized by having no long range symmetry in the atomic positions. Examples of amorphous structures include glass, or glass-like structures. Some embodiments may provide finish layers having a crystalline structure (e.g., nanocrystalline structure) throughout essentially the entire finish layer. Some embodiments may provide finish layers having an amorphous structure throughout essentially the entire layer.

In certain embodiments, the finish layer is electrically conductive. For example, the layer may have a contact resistance of less than or equal to 1000 milliohms, less than or equal to 900 milliohms, less than or equal to 800 milliohms, less than or equal to 700 milliohms, less than or equal to 600 milliohms, less than or equal to 500 milliohms, less than or equal to 400 milliohms, less than or equal to 300 milliohms, or less than or equal to 200 milliohms. In some embodiments, the finish layer has a contact resistance of greater than or equal to 100 milliohms, greater than or equal to 200 milliohms, greater than or equal to 300 milliohms, greater than or equal to 400 milliohms, greater than or equal to 500 milliohms, greater than or equal to 600 milliohms, greater than or equal to 700 milliohms, greater than or equal to 800 milliohms, or greater than or equal to 900 milliohms. Combinations of the above recited ranges are also possible (e.g., the layer has a contact resistance of greater than or equal to 100 milliohms and less than or equal to 1000 milliohms, the layer has a contact resistance of greater than or equal to 500 milliohms and less than or equal to 800 milliohms). Other combinations are also possible.

The contact resistance of the finish layer may be determined using the ANSI standard method ANSI/EIA-364-23B-2000, entitled “Low Level Contact Resistance Test Procedure for Electrical Connectors and Sockets.”

The finish layer may also have any of a variety of desirable appearances. Appearance is an increasingly important property in certain electrical contact applications, including ones used with handheld devices such as mobile devices and/or tablets. In some embodiments, the layer may have a particularly dark color when viewed by the naked human eye (e.g., the layer may appear black to the naked human eye). In some aspects, the darkness and/or color of the finish layer may be determined using the International Commission on Illumination (CIE) color space, designated herein as CIE L*a*b*. In some embodiments, when using CIE L*a*b*, the value of L* may determine the darkness of the layer, the value of a* may determine the green-red color components of the layer, and/or the value of b* may determine the blue-yellow color components of the layer. the CIE L*a*b* color space may be determined using suitable calibrated devices and techniques.

The finish layer may have any of a variety of suitable L* values which are representative of the dark color of the layer. In some embodiments, the finish layer has a L* value of less than or equal to 60, less than or equal to 50, less than or equal to 40, less than or equal to 30, less than or equal to 20, or less than or equal to 10. In some embodiments, the finish layer may have a L* value of greater than 0 or greater than 20. Combinations of the above recited ranges a also possible (e.g., the finish layer has a L* value of greater than 0 and less than or equal to 60). Other ranges are also possible.

According to some embodiments, the L* value of the finish layer may be adjusted using a heat treatment.

The finish layer may have any of a variety of suitable a* values. For example, the finish layer may have an a* value of greater than or equal to −20, greater than or equal to −15, greater than or equal to −10, greater than or equal to −5, greater than or equal to 0, greater than or equal to 5, greater than or equal to 10, or greater than or equal to 15. In some embodiments, the finish layer has an a* value of less than or equal to 20, less than or equal to 15, less than or equal to 10, less than or equal to 5, less than or equal to 0, less than or equal to −5, less than or equal to −10, or less than or equal to −15. Combinations of the above recited ranges are also possible (e.g., the finish layer has an a* value of greater than or equal to −20 and less than or equal to 20, the finish layer has an a* value of greater than or equal to −10 and less than or equal to 10). Other ranges are also possible.

The finish layer may have any of a variety of suitable b* values. For example, the finish layer may have an b* value of greater than or equal to −20, greater than or equal to −15, greater than or equal to −10, greater than or equal to −5, greater than or equal to 0, greater than or equal to 5, greater than or equal to 10, or greater than or equal to 15. In some embodiments, the finish layer has an a* value of less than or equal to 20, less than or equal to 15, less than or equal to 10, less than or equal to 5, less than or equal to 0, less than or equal to −5, less than or equal to −10, or less than or equal to −15. Combinations of the above recited ranges are also possible (e.g., the finish layer has an b* value of greater than or equal to −20 and less than or equal to 20, the finish layer has an b* value of greater than or equal to −10 and less than or equal to 10). Other combinations are also possible.

The finish layer may have any of a variety of suitable thicknesses. For example, the layer may have a thickness of greater than or equal to 0.1 micrometers, greater than or equal to 0.2 micrometers, greater than or equal to 0.3 micrometers, greater than or equal to 0.4 micrometers, greater than or equal to 0.5 micrometers, greater than or equal to 1 micrometers, greater than or equal to 1.5 micrometers, greater than or equal to 2 micrometers, or greater than or equal to 2.5 micrometers. In some embodiments, the finish layer has a thickness of less than or equal to 3 micrometers, less than or equal to 2.5 micrometers, less than or equal to 2 micrometers, less than or equal to 1.5 micrometers, less than or equal to 1 micrometer, less than or equal to 0.5 micrometers, less than or equal to 0.4 micrometers, less than or equal to 0.3 micrometers, or less than or equal to 0.2 micrometers. Combinations of the above recited ranges are also possible (e.g., the finish layer has a thickness of greater than or equal to 0.1 micrometers and less than or equal to 3 micrometers, the finish layer has a thickness of greater than 0.2 micrometers and less than or equal to 1 micrometer). Other combinations are also possible.

In certain embodiments, the thickness of the finish layer may be adjusted depending on the deposition technique. According to some embodiments, it may be beneficial to have a substantially thick layer (e.g., greater than or equal to 1 micrometer) to improve corrosion and/or wear resistance.

The finish layer may be formed by any of a variety of suitable methods. For example, the layer may be formed on the substrate by deposition. In some embodiments, the deposition technique may comprise physical vapor deposition (PVD), atomic layer deposition (ALD), chemical vapor deposition (CVD), and/or electrodeposition. In some cases, electrodeposition processes may be preferred.

In certain embodiments, the parameters of the deposition are varied such that at least a portion of one or more metal oxide is co-deposited with at least a portion of one or more metals. For example, in some embodiments, the finish layer comprises one or more metal oxides and one or more metals in a blend and/or mix.

As described above, the finish layer may be formed on a substrate. In some cases, the substrate may comprise an electrically conductive material, such as a metal, metal alloy, intermetallic material, or the like. Suitable substrates include steel, copper, aluminum, brass, bronze, nickel, polymers with conductive surfaces and/or surface treatments, amongst others. In some embodiments, substrates comprising copper (e.g., copper metal substrates) are preferred.

It should be understood that the term “formed on” refers to a layer that is formed directly or indirectly on a substrate. When a layer is formed indirectly on a substrate, one or more intervening layers may be formed between the substrate and the layer, as described further below. When a layer is formed directly on a substrate, no intervening layers are present.

In certain embodiments, the electrical contact may comprise more than one layer (e.g., two, three, four, five, etc.). In some such embodiments, one or more intervening layers may be formed between the substrate and the finish layer. Such intervening layers may include an alloy layer comprising, for example, a nickel-based alloy (e.g., nickel-tungsten alloy, nickel-molybdenum alloy) and/or a tungsten-based alloy (e.g., cobalt-tungsten alloy), and/or a precious metal layer comprising, for example, a precious metal (e.g., Ru, Os, Rh, Ir, Pd, Pt, Ag, and/or Au). In some embodiments, the inclusion of one or more intervening layers, in addition to the finish layer, may provide the electrical contact with increased durability, corrosion and/or wear resistance, and/or improved electrical conductivity.

In certain embodiments, one or more intervening layers may be formed on the substrate prior to finish layer. In some such embodiments, the one or more intervening layers may be formed directly on the substrate. In some embodiments, one or more overlaying layers may be formed on the finish layer. In some such embodiments, when the one or more overlaying layers are formed on the finish layer, it may be preferable for such layers to be transparent so as to not shield the dark color of the finish layer. It should be understood that not all embodiments have an intervening layer formed between the substrate and the finish layer or an overlaying layer formed on the finish layer. That is, in some embodiments, the electrical contact includes only a substrate (e.g., copper substrate) and a finish layer; in some embodiments, the electrical contact includes a substrate and one or more intervening layer between the substrate and the contact layer but does not include any overlaying layers (i.e., the top layer of the contact is the finish layer); and, in some embodiments, the contact does not include any intervening layers between the substrate and the finish layer (i.e., the finish layer is formed directly on the substrate) but does include one or more overlaying layers on the finish layer. In some embodiments, the contact includes both intervening layer(s) and overlaying layer(s) in addition to the finish layer.

Examples of suitable alloy-based (e.g., nickel and/or tungsten-alloy based) or metal-based (e.g., precious metal) intervening and/or overlaying layers are described in commonly-owned U.S. Pat. No. 8,652,649; U.S. Patent Application Publication No. 2017-0253008; U.S. Patent Application Publication No. 2017-0253983; and U.S. Pat. No. 8,445,116, each of which is incorporated herein by reference in its entirety.

In certain embodiments, the electrical contact may be an electrical connector. In some embodiments, the electrical contact may be part of a cord used to connect a handheld device (e.g., a cell phone, tablet, laptop computer) to a power source (e.g., wall plug) or another electronic device. The electrical contact (e.g., in the form of a male type plug contact) may be mated with a corresponding contact (e.g., female type contact) to form an electrical connection that provides power, signal, or an electrical grounding for the device. In some embodiments, the electrical contact may be configured to provide the mechanical attachment to the corresponding contact.

### Example: Electrically Conductive Material Formed on a Copper Substrate

The following example describes the preparation and properties of an electrically conductive material applied to a copper substrate.

A series of copper substrates were coated with a sub-micrometer layer of Ru metal, followed by a 1 micrometer layer of RuO₂, by electrodeposition. The electrodeposition parameters were varied so that some fraction of ruthenium metal was co-deposited with the ruthenium oxide. Sample duplicates (1b, 2b, and 3b) were heated to 200° C. for 10 minutes. The properties of the finish layers are presented in Table 1.

TABLE 1

| | | Low Level Contact | Color | | |
|---|---|---|---|---|---|
| Sample | Condition | Resistance (mΩ) | L* | a* | b* |
| 1a | As made | 250 | 45 | 3 | 7 |
| 1b | Heat treated | 1810 | 50 | −4 | −18 |
| 2a | As made | 90 | 44 | 1 | 6 |
| 2b | Heat treated | 2510 | 55 | −7 | −11 |
| 3a | As made | 83 | 45 | 1 | 7 |
| 3b | Heat treated | 1610 | 50 | −6 | −13 |

1. An electrical contact structure, comprising:
a substrate, and
a finish layer formed on the substrate, wherein the finish layer has a contact resistance of less than 1000 milliohms and a L* value of less than or equal to 60 as measured by CIE L*a*b*.

2. An electrical contact structure, comprising:
a substrate, and
a finish layer formed on the substrate, the finish layer comprising:
a ruthenium oxide and/or an iridium oxide, and
one or more metals in an amount of greater than 0 at. % and less than or equal to 90 at. %.

3. The electrical contact structure of claim 1, wherein the finish layer comprises one or more metal oxides.

4. The electrical contact structure of claim 1, wherein the finish layer comprises a ruthenium oxide.

5. The electrical contact structure of claim 1, wherein the finish layer comprises an iridium oxide.

6. The electrical contact structure of claim 1, wherein the finish layer comprises one or more metals.

7. The electrical contact structure of claim 1, wherein the one or more metals in the finish layer is selected from the group consisting of Pt, Au, Ru, Jr, Rh, and mixtures thereof.

8. The electrical contact structure of claim 1, wherein the finish layer comprises the one or more metals in an amount between 0 atomic % and 90 atomic %.

9. The electrical contact structure of claim 1, wherein the finish layer has a thickness of at least 0.1 micrometers.

10. The electrical contact structure of claim 1, wherein the substrate comprises copper.

11. The electrical contact structure of claim 1, further comprising one or more intervening layers formed between the substrate and the finish layer.

12. The electrical contact structure of claim 1, further comprising one or more overlaying layers formed on the finish layer.
